(19) United States
(12) Patent Application Publication
(10) Pub. No.: US 2007/0013357 A1
(43) Pub. Date: Jan. 18, 2007

(54) Inverter apparatus with built-in programmable logic-controller

(75) Inventors: Tai-Tsung Huang, Taoyuan Hsien (TW); Hsiao-Yuan Wen, Taoyuan Hsien (TW); Yung-Chuan Lu, Taoyuan Hsien (TW)

Correspondence Address: HDSL, 4331 STEVENS BATTLE LANE, FAIRFAX, VA, 22033, US

(73) Assignee: Delta electronics, Inc.

(21) Appl. No.: 11/178,328

(22) Filed: Jul. 12, 2005

(51) Int. Cl. B23K 11/24

(52) U.S. Cl. 323/318

(57) ABSTRACT

An inverter apparatus is incorporated with a built-in programmable logic-controller (PLC). The PLC includes internal memory for directly outputting control signal to provide inverter operation control without time delay and noise. The inverter apparatus includes external terminals for function assignment and an external program can be coded for expanding the function of the inverter apparatus through the external terminals. The inverter apparatus of the present invention can overcome the problems of limited function and complicated wiring.

### BACKGROUND OF THE INVENTION

1. Field of the Invention

The present invention relates to an inverter apparatus with a built-in programmable logic-controller (PLC), more particularly to an inverter apparatus with a PLC incorporated therein and an external program can be coded to expand the function of the external terminals of the inverter apparatus.

2. Description of Prior Art

Inverter devices are extensively used in electrical products such as air conditioner and refrigerators for function control and energy saving. However, the inverter devices require suitable interface and dedicated program to complete the function thereof. As shown in FIG. 1, the inverter device is electrically connected to a programmable logic-controller (PLC) through external terminals thereof to execute the function stored in the PLC.

The inverter devices have predetermined functions once the program is burned into the PLC and is controlled by the PLC by following ways:

1. The PLC send voltage signals or current signals through the analog input/output pins. However, the signal integrity may be influenced by noise.

2. The PLC controls frequency through the digital In/Out pins by multi input scheme. However, there are only four feasible frequencies because the limitation in pin numbers.

3. The PLC controls the inverter devices through the communication pins, for example, network connection lines. However, dedicated network interface cards are needed and the communication speed is generally insufficient.

The conventional inverter devices are controlled by the PLC through the external terminals thereof. Therefore, additional PLC is required and the wiring is complicated. Moreover, the PLC becomes incompatible with the external terminal of the inverter devices as the progress in electrical device and demands in inverter device functions. Therefore, the PLC control is insufficient for inverter devices. For example, after the inverter device is stopped by the PLC and is requested to resume its operation, some user requests the inverter devices to resume with original frequency sensed by a sensor. Alternatively, some user requests the inverter devices to resume with new input frequency while the original frequency is reset. As can be seen from above description, the inverter devices with fixed external terminal cannot meet user requirement for versatile functions.

Moreover, the conventional inverter device also has the drawbacks of wrong pin connection, open circuit or poor contact because the wiring between the PLC and the external terminals is complicated.

### SUMMARY OF THE INVENTION

The present invention is intended to provide an inverter apparatus with a built-in PLC to simplify wiring, augment function and reduce cost.

Accordingly, the present invention provides an inverter apparatus with a built-in programmable logic-controller (PLC), comprising: an inverter circuit; a PLC integrated into the inverter apparatus; wherein the PLC is electrically connected to the inverter circuit through an internal wiring.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a conventional layout for inverter and PLC.

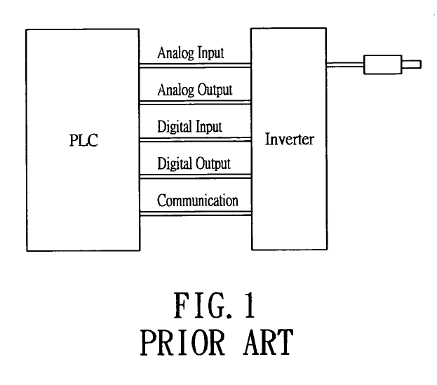

FIG. 2 shows the block diagram of the inverter apparatus with a built-in PLC according to the present invention.

### DETAILED DESCRIPTION OF THE INVENTION

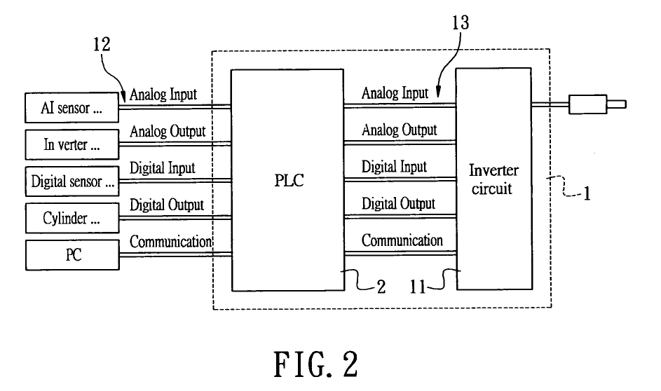

With reference to FIG. 2, the inverter apparatus 1 with built-in PLC comprises an inverter circuit 11 and a built-in PLC 2 arranged in the inverter apparatus 1. The built-in PLC 2 is connected to the inverter circuit 11 through internal wiring 13 to form the inverter apparatus 1 with built-in PLC, which has low cost and versatile functions.

The inverter apparatus 1 comprises a plurality of external terminals 12 for pin function assignment and connection, such as analog input/output pin, digital input/output pin, communication pins which are originally used by PLC. Those pins can be adapted by user for other usages. For example, the analog input pin can be connected to an AI sensor. The analog output pin can be connected to an inverter. The digital input pin can be connected to a digital sensor. The communication pin can be used for communication setting for connecting to and controlling another inverter or personal computer.

In other words, when user issues a stop command to the inverter apparatus 1 through the PLC 2, the inverter apparatus 1 can be resumed with an original frequency or a new frequency input by user after resetting. This can be achieved by setting the function of at least one external terminal 12 such as analog input pin and by setting suitable program. The inverter apparatus 1 can be resumed with the original frequency or the new frequency input by user after resetting, when the sensor outputs signal to activate the inverter apparatus 1.

The external program can be coded to set the analog input pin to connect to sensor control function and to set the analog output pin for selecting original frequency for resuming operation. The digital output pin is set for inputting new frequency. Therefore the sensor can issue signal to command the inverter apparatus 1 to resume operation with original frequency and the analog output pin outputs control signal. Alternatively, the inverter apparatus 1 can also resume operation with user input frequency, which is enabled by the digital output pin. Therefore, the resume operation of the inverter apparatus 1 can be customized by user.

In the present invention, the PLC 2 is embedded in the inverter apparatus 1, the inverter apparatus 1 is directly controlled by the internal memory of the PLC 2. The inverter apparatus 1 according to the present invention has following advantages in comparison with conventional inverter apparatus.

1. The PLC 2 is directly embedded into the inverter apparatus 1 to control the inverter apparatus 1; there is no time delay and noise problem.

2. There is no human factor wiring error, wiring aging and poor contact problems.

3. The human factor error, wire aging and poor contact problems can be solved.

4. The device is more compact with low cost and free from complicated wiring.

Furthermore, the inverter apparatus 1 can be integrated into a CPU after the PLC 2 is integrated into the inverter apparatus 1.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An inverter apparatus with a built-in programmable logic-controller (PLC), comprising:
an inverter circuit;
a PLC integrated into the inverter apparatus;
wherein the PLC is electrically connected to the inverter circuit through an internal wiring.

2. The inverter apparatus as in claim 1, further comprising external terminals for function assignment, wherein the functions of the external terminals can be assigned and controlled by an external program.

3. The inverter apparatus as in claim 2, wherein the external terminals comprise at least analog input/output pins, digital input/output pins and communication pins.

4. The inverter apparatus as in claim 1, wherein the inverter circuit is integrated into a CPU.
